(19) United States
(12) Patent Application Publication
(10) Pub. No.: US 2010/0141408 A1
(43) Pub. Date: Jun. 10, 2010

(54) Audio amplifier apparatus to drive a panel to produce both an audio signal and haptic feedback

(76) Inventors: Anthony Stephen Doy, Los Gatos, CA (US); Mark Adam Cherry, Campbell, CA (US)

Correspondence Address: HAVERSTOCK & OWENS LLP, 162 NORTH WOLFE ROAD, SUNNYVALE, CA, 94086, US

(21) Appl. No.: 12/315,690

(22) Filed: Dec. 5, 2008

(51) Int. Cl. G08B 3/10; G06F 3/041

(52) U.S. Cl. 340/407.2; 345/173

(57) ABSTRACT

A control panel apparatus includes a control panel that is vibrated to generate sound and/or haptic feedback. The control panel apparatus is configured to receive tactile input, such as a touchscreen, and to provide tactile feedback so as to function like a haptic panel, in response to a haptic signal component of a driving signal. The control panel is also configured to function as an audio speaker in response to an audio signal component of the driving signal. The haptic signal has a wider bandwidth, in the range of approximately 100-400 Hz, and the audio signal has a narrower bandwidth, in the range of approximately 20 Hz-20 kHz. The driving signal is configured to include either or both of the haptic signal and the audio signal. One or more drive elements are coupled to a control panel, each drive element driven by a driving signal. Each drive element converts the electrical driving signal to mechanical movement, thereby vibrating the control panel. In the case of multiple drive elements, each drive element is coupled to a different portion of the control panel.

### FIELD OF THE INVENTION

The present invention relates to the field of touch panels or touchscreens. More particularly, the present invention relates to the field of touch panels or touchscreens that use an audio amplifier to generate both sound and haptic feedback.

### BACKGROUND OF THE INVENTION

Many electrical devices are incorporating touchscreen type displays. A touchscreen is a display that detects the presence, location, and pressure of a touch within the display area, generally by a finger, hand, stylus, or other pointing device. The touchscreen enables a user to interact with the display panel directly without requiring any intermediate device, rather than indirectly with a mouse or touchpad. Touchscreens can be implemented in computers or as terminals to access networks. Touchscreens are commonly found in point-of-sale systems, automated teller machines (ATMs), mobile phones, personal digital assistants (PDAs), portable game consoles, satellite navigation devices, and information appliances.

There are a number of types of touchscreen technologies. A resistive touchscreen panel is composed of several layers including two thin metallic electrically conductive and resistive layers separated by thin space. When some object touches the touchscreen panel, the layers are connected at certain point. In response to the object contact, the panel electrically acts similar to two voltage dividers with connected outputs. This causes a change in the electrical current that is registered as a touch event and sent to the controller for processing.

A capacitive touchscreen panel is coated, partially coated, or patterned with a material that conducts a continuous electrical current across a sensor. The sensor exhibits a precisely controlled field of stored electrons in both the horizontal and vertical axes to achieve capacitance. The human body is also an electrical device that has stored electrons and therefore also exhibits capacitance. When a reference capacitance of the sensor is altered by another capacitance field, such as a finger, electronic circuits located at each corner of the panel measure the resultant distortion in the reference capacitance. The measured information related to the touch event is sent to the controller for mathematical processing. Capacitive sensors can either be touched with a bare finger or with a conductive device being held by a bare hand. Capacitive sensors also work based on proximity, and do not have to be directly touched to be triggered. In most cases, direct contact to a conductive metal surface does not occur and the conductive sensor is separated from the user's body by an insulating glass or plastic layer. Devices with capacitive buttons intended to be touched by a finger can often be triggered by quickly waving the palm of the hand close to the surface without touching.

Other types of touchscreen technologies include surface acoustic wave technology that uses ultrasonic waves, an infrared touchscreen panel, strain gauge panels coupled to springs, optical imaging, dispersive signal technology, and total internal reflection.

Haptic technology refers to technology which interfaces to the user via the sense of touch by applying forces, vibrations and/or motions to the user. Either the entire device is vibrated, such as a cellular telephone, or only the control panel is vibrated, such as a haptic panel. Haptic, or tactile, feedback provides confirmation of a button touch or press on a touchscreen control panel, or a confirmation of an action taken.

Haptic feedback is conventionally provided by attaching a transducer to the touchscreen, and vibrating the entire panel using the transducer. A transducer converts an electrical signal to mechanical energy. Piezoelectric actuators are sometimes used as the transducers. The piezoelectric actuators vibrate when excited by an electrical signal.

### SUMMARY OF THE INVENTION

A control panel apparatus includes a control panel that is vibrated to generate sound and/or haptic feedback. The control panel apparatus is configured to receive tactile input, such as a touchscreen, and to provide tactile feedback so as to function like a haptic panel, in response to a haptic signal component of a driving signal. The control panel is also configured to function as an audio speaker in response to an audio signal component of the driving signal. The haptic signal has a wider bandwidth, in the range of approximately 100-400 Hz, and the audio signal has a narrower bandwidth, in the range of approximately 20 Hz-20 kHz. The driving signal is configured to include either or both of the haptic signal and the audio signal. One or more drive elements are coupled to a control panel, each drive element driven by a driving signal. Each drive element converts the electrical driving signal to mechanical movement, thereby vibrating the control panel. In the case of multiple drive elements, each drive element is coupled to a different portion of the control panel. The control panel apparatus can be configured with multiple channels, each channel manifested by a specific driving signal being applied to a specific drive elements. In some embodiments, the control panel is coupled to a device chassis using compliant suspensions that enable the control panel to move independently of the chassis. In other embodiments, the edges of the control panel are fixedly coupled to the chassis and the non-fixed portion of the control panel flexes. The control panel apparatus can be implemented as part of any device that utilizes a display and speaker, including, but not limited to, a cordless telephone, a cellular telephone, a desktop telephone, a personal digital assistant (PDA), a music player such as an MP3 player, and a computing device.

In one aspect, an apparatus is configured to provide an audio response and tactile feedback to a user. The apparatus includes an audio signal processor configured to output an audio signal, a haptic signal processor configured to output a haptic signal, a summing circuit coupled to the audio signal processor and to the haptic signal processor, wherein the summing circuit is configured to sum the audio signal and the haptic signal to form a combined signal, a driver circuit coupled to the summing circuit, wherein the driver circuit is configured to output a driving signal in response to the combined signal, a drive element coupled to the driver circuit, wherein the drive element is configured to generate mechanical energy in response to the driving signal, and a control panel coupled to the drive element, wherein the control panel is configured to provide tactile feedback in response to a haptic component of the driving signal and to provide sound in response to an audio component of the driving signal. The control panel is configured to function as a haptic panel to output tactile feedback and audio, and is configured to function as a touchscreen panel to measure tactile input. In this case, the control panel can be a capacitive touchscreen panel or a resistive touchscreen panel, and the touchscreen panel functionality can be operative while the control panel is outputting audio. The driver circuit can be configured to adjust an audio output volume generated by the control panel. In some embodiments, the haptic signal has a frequency response in the range of approximately 100-400 Hz., and the audio signal has a frequency response in the range of approximately 20 Hz-20 kHz. The apparatus also includes a chassis, and the control panel is coupled to the chassis. In some embodiments, the apparatus also includes one or more compliant suspension elements positioned between the control panel and the chassis. The audio signal processor can be configured to adjust an amplitude, a phase, or the amplitude and phase of the audio signal, thereby adjusting an acoustic output of the apparatus. The drive element can be a piezoelectric drive element or a moving coil and magnet. The apparatus can also include one or more additional driver circuits and one or more additional drive elements, wherein the one or more additional driver circuits are coupled in parallel to the driving circuit and each additional drive element is coupled to one of the additional driver circuits. The apparatus can also include one or more additional drive elements coupled in parallel to the drive element and to the driver circuit.

In another aspect, the apparatus is alternatively configured to include a plurality of audio signal processors each configured to output an audio signal, a haptic signal processor configured to output a haptic signal, a plurality of summing circuits, each summing circuit is also coupled to one of the plurality of audio signal processors and to the haptic signal processor, wherein each summing circuit is configured to sum the audio signal and the haptic signal to form a combined signal, a plurality of driver circuits, wherein each of the plurality of driver circuits is coupled to one of the plurality of summing circuits, further wherein each of the plurality of driver circuits is configured to output a driving signal in response to the combined signal, a plurality of drive elements, wherein each of the plurality of drive elements is coupled to one of the driver circuits such that each drive element is driven by an independent audio signal and a common haptic signal, further wherein each of the plurality of drive elements is configured to generate mechanical energy in response to the driving signal, and a control panel coupled to the plurality of drive elements, wherein the control panel is configured to provide tactile feedback in response to a haptic component of the driving signal and to provide sound in response to an audio component of each driving signal input to each of the plurality of drive elements.

In yet another aspect, the apparatus is alternatively configured to include a plurality of audio signal processors each configured to output an audio signal, a plurality of haptic signal processors each configured to output a haptic signal, a plurality of summing circuits, wherein each of the plurality of summing circuits is also coupled to one of the plurality of audio signal processors and to one of the plurality of haptic signal processors, wherein each summing circuit is configured to sum the audio signal and the haptic signal to form a combined signal, a plurality of driver circuits, wherein each of the plurality of driver circuits is coupled to one of the plurality of summing circuits, further wherein each of the plurality of driver circuits is configured to output a driving signal in response to the combined signal, a plurality of drive elements, wherein each of the plurality of drive elements is coupled to one of the driver circuits such that each drive element is driven by an independent audio signal and an independent haptic signal, further wherein each of the plurality of drive elements is configured to generate mechanical energy in response to the driving signal, and a control panel coupled to the plurality of drive elements, wherein the control panel is configured to provide tactile feedback in response to a haptic component of the driving signal and to provide sound in response to an audio component of each driving signal input to each of the plurality of drive elements.

### BRIEF DESCRIPTION OF THE DRAWINGS

FIG. 1 illustrates a cut-out side view of a control panel apparatus according to a first embodiment of the present invention.

FIG. 2 illustrates an alternative configuration of the control panel apparatus.

FIG. 3 illustrates a cut-out side view of the control panel apparatus including two drive elements.

FIG. 4 illustrates a schematic block diagram of an exemplary drive element control circuit according to a first embodiment of the present invention.

FIG. 5 illustrates a schematic block diagram of an exemplary drive element control circuit according to a second embodiment of the present invention.

FIG. 6 illustrates a schematic block diagram of an exemplary drive element control circuit according to a third embodiment of the present invention.

FIG. 7 illustrates a schematic block diagram of an exemplary drive element control circuit according to a fourth embodiment of the present invention.

FIG. 8 illustrates a schematic block diagram of an exemplary drive element control circuit according to a fifth embodiment of the present invention.

Embodiments of the control panel apparatus are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

Embodiments of the present invention are directed to a control panel apparatus. Those of ordinary skill in the art will realize that the following detailed description of the present invention is illustrative only and is not intended to be in any way limiting. Other embodiments of the present invention will readily suggest themselves to such skilled persons having the benefit of this disclosure.

Reference will now be made in detail to implementations of the present invention as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present application, some of the components, process steps, and/or data structures may be implemented using various types of processing systems, including hardware, software, or any combination thereof. In addition, those of ordinary skill in the art will recognize that devices of a less general purpose nature, such as hardwired devices, application specific integrated circuits (ASICs), or the like, may also be used without departing from the scope and spirit of the inventive concepts disclosed herein.

Embodiments of a control panel apparatus include a control panel configured with both touch sense input functionality, such as a touchscreen, and haptic response functionality that provides tactile feedback to a user. The haptic response is provided by one or more drive elements used to vibrate or otherwise physically move the surface of the control panel in order to provide physical confirmation of a selection event or button press. Such haptic, or vibrational, feedback is generated by modulating the drive elements with a driving signal provided by amplifiers or signal generators. The driving signal includes a haptic signal component configured as a basic or complex waveform, such as a square wave or sine wave. In some embodiments, the haptic signal component has a frequency less than 1 KHz, for example between 100-400 Hz.

The control panel apparatus is further configured to supplement the driving signal with an audio signal component such that the one or more drive elements and the control panel function as an audio speaker. Vibrating the control panel at the proper frequencies vibrates the surrounding air in such a manner as to generate sound. The drive elements are transducers, such as ceramic drive elements, piezoelectric drive elements, or moving coil and magnet elements, which provide mechanical energy, such as vibration, in response to an electrical signal, such as the driving signal. The driving signal can be processed to include either the haptic signal, the audio signal, or both. In response to the driving signal, the control panel provides tactile feedback and/or functions as an audio speaker. The touchscreen functionality of the control panel is fully operative while the tactile feedback and/or the audio are provided.

The control panel apparatus includes an audio signal processor to output a desired audio signal and a haptic signal processor to output a desired haptic signal. The haptic signal processor and the audio signal processor each comprise hardware and software components. In some embodiments, the haptic signal processor and the audio signal processor use separate hardware components. In other embodiments, one, some, or all of the hardware components are commonly used by the haptic signal processor and the audio signal processor. The audio signal and the haptic signal are summed and input to a drive element processing circuit that generates the driving signal. If there is no audio signal, then the driving signal includes only the haptic signal component. If there is no haptic signal, then the driving signal includes only the audio signal component. The audio levels and the frequency response of the audio generated by the control panel can be adjusted. In some embodiments, the audio levels and frequency response are set such that the control panel functions as a speaker phone. In other embodiments, the audio levels and frequency response are set such that the control panel functions as a telephone receive speaker, such as in a wireless mobile device, where the user positions the control panel close to or against the user's ear. In one exemplary application, the audio levels and frequency response are set such that equalization and signal processing enable a mobile cellular telephone including the control panel apparatus to conform to 3G Rx path specifications as described in 26131-710 and 26132-710.

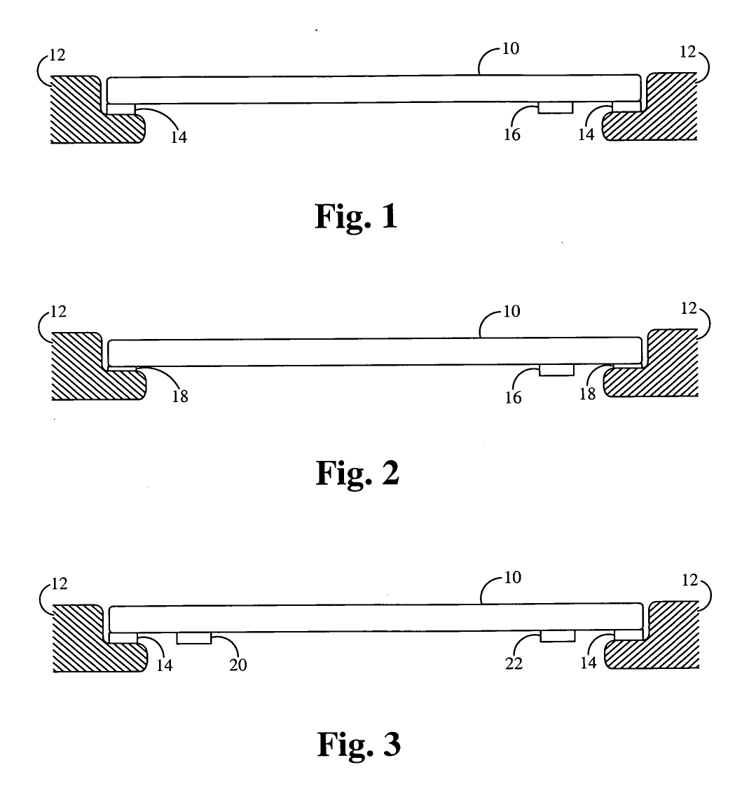

FIG. 1 illustrates a cut-out side view of a control panel apparatus according to a first embodiment of the present invention. The control panel apparatus includes a control panel 10 coupled to a chassis 12 via compliant suspension 14. The compliant suspension 14 can be a single element positioned proximate to or at the perimeter of the control panel 10. Alternatively, the compliant suspension 14 represents a plurality of elements. In some embodiments, the compliant suspension 14 is attached to both the chassis 12 and the control panel 10 using any conventional attachment material including, but not limited to, adhesive material, bonding material, solder, or the like that fixes the compliant suspension 14 to the chassis 12 and to the control panel 10. In some embodiments, the compliant suspension 14 is configured to allow the entire control panel 10 to move back and forth, similar to the movement of a piston. In other embodiments, the perimeter of the control panel 10 is fixed in place and an inner portion of the control panel 10 “flexes” back and forth.

The compliant suspension 14 is configured to enable the control panel 10 to vibrate up and down, independent of the chassis 12, thereby generating the tactile feedback and the audio speaker function. In this configuration, the entire control panel 10 vibrates up and down. FIG. 2 illustrates an alternative configuration of the control panel apparatus where the compliant suspension is eliminated and the control panel 10 is coupled to the chassis 12 via an attach material 18. In this alternative configuration, the perimeter of the control panel 10 is fixedly coupled to the chassis 12 via the attach material 18. In this configuration, the edges of the control panel 10 are anchored to the chassis 12 and the non-fixed portion of the control panel 10 vibrates, or flexes, up and down to generate the tactile feedback and the audio speaker function. The attach material 18 is made of any conventional attachment material including, but not limited to, adhesive material, bonding material, solder, or the like that fixes the perimeter of the control panel 10 to the chassis 12.

A drive element 16 is coupled to the control panel 10. The drive element 16 is a transducer that converts electrical signals to mechanical movement. In some embodiments, the drive element is a ceramic drive element or a piezoelectric drive element. In other embodiments, the drive element is a moving coil and magnet. It is understood that alternative conventional transducers can be used that convert electrical signals to mechanical movement. Driving signals are received by the drive element 16, which in turn vibrates at a frequency and amplitude determined by the driving signal. Movement of the drive element 16 causes a corresponding movement, or vibration, of the control panel 10. A lower bandwidth component, such as in the range of 100-400 Hz, uses a relatively low frequency vibration to generate the tactile feedback such that the control panel functions as a haptic control panel. The portion of the driving signal that generates the tactile feedback response is referred to as the haptic signal. A wider bandwidth component, such as in the range of 20 Hz to 20 kHz, typically uses a relatively high frequency vibration to generate sound such that the control panel functions as an audio speaker. The portion of the driving signal that generates the audio speaker functionality is referred to as the audio signal. The relative position of the drive element 16 shown in FIG. 1 is for exemplary purposes only. The drive element 16 can be positioned at the edge, the center, or anywhere in-between on the control panel 10.

In some embodiments, the control panel 10 is also configured as a touchscreen, such as a conductive touchscreen panel or a resistive touchscreen panel. The touchscreen functionality of the control panel 10 is fully operative while the control panel 10 is also functioning as an audio speaker or providing tactile feedback. In other words, the touchscreen functionality is operative while the drive element 16 is actuated by a driving signal. The touchscreen functionality that detects when and where the panel is touched for user input is independent of the tactile feedback and audio speaker functionality.

Although FIG. 1 shows a single drive element 16, the control panel apparatus can be configured with multiple drive elements. FIG. 3 illustrates a cut-out side view of the control panel apparatus including two drive elements 20 and 22. The relative positions of the drive elements 20 and 22 are shown for exemplary purposes only. It is contemplated that more than two drive elements can be used.

In some embodiments, each of the drive elements 20 and 22 receive the same driving signal. In other embodiments, a different driving signal is sent to each of the drive elements 20 and 22, as described in greater detail below.

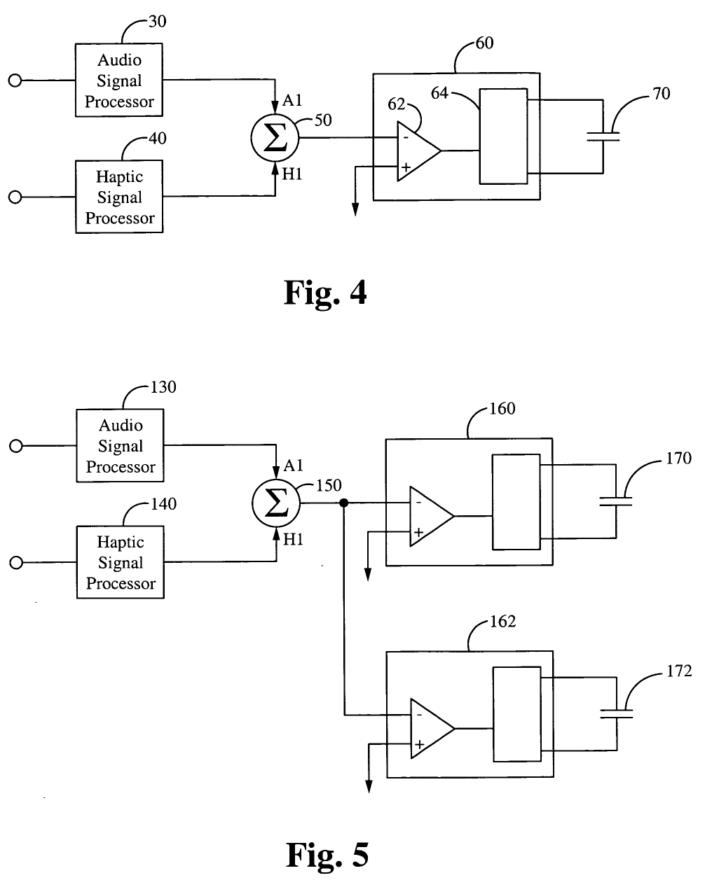

FIG. 4 illustrates a schematic block diagram of an exemplary drive element control circuit according to a first embodiment of the present invention. An audio signal processor 30 is configured to output an audio signal A1, and a haptic signal processor 40 is configured to output a haptic signal H1. As used herein, a haptic signal is a signal with a frequency in the range of about 100-400 Hz, which results in the tactile feedback when used to drive the drive element. Also as used herein, an audio signal is a signal capable of being heard by a person with average hearing, which is considered to be a frequency in the range of about 20 Hz-20 KHz. In telecommunication applications, a lower frequency limit of an audio signal is approximately 300 Hz. Application of the audio signal, when used to drive the drive element, results in the audio speaker functionality.

The audio signal processor 30 is configured to control the amplitude, phase, frequency, linearity, distortion, and other characteristics to generate a desired audio signal. Although the haptic signal used to generate tactile feedback requires a narrower bandwidth than the audio signal, in most cases the haptic signal is a square wave or sine wave, and the haptic signal processor 40 can be configured to enable similar signal processing functionality as the audio signal processor 30 in order to generate a haptic signal with desired signal characteristics.

A summing circuit 50 sums the audio signal A1 and the haptic signal H1 to form a combined signal. The combined signal is input to the drive element driver circuit 60. The drive element driver circuit 60 includes an amplifier 62 and an output stage 64. The amplifier 62 receives and amplifies the combined signal output from the summing circuit 50. The amplified signal is input to the output stage 64, which outputs the driving signal used to drive a drive element 70, such as the drive element 16 of FIG. 1. The driving signal provided to the drive element 70 includes an audio signal portion and a haptic signal portion. In some cases, the haptic signal portion is zero (no haptic signal) and the driving signal is comprised entirely of the audio signal portion (the audio signal). In this case, the control panel is driven as an audio speaker. In other cases, the audio signal portion is zero (no audio signal) and the driving signal is comprised entirely of the haptic signal portion (the haptic signal). In this case, the control panel is driven to provide tactile feedback. In still other cases, both the audio signal portion and the haptic signal portion are present in the driving signal. In this case, the control panel is driven simultaneously as an audio speaker and to provide tactile feedback. However, the audio signal and the control panel are tuned to provide a specific audio response. Touching the control panel, as in using the touchscreen functionality or receiving tactile feedback, while the control panel is functioning as an audio speaker compromises the audio response to some degree.

The audio signal portion of the driving signal has an extended frequency response, especially when compared to the haptic signal portion. Finer control is applied to the audio signal portion of the driving signal. The drive element driver circuit 60 is configured to provide a high-output voltage swing to drive the drive element and to provide audio speaker functionality of the control panel. An exemplary configuration of the drive element driver circuit 60 is the class G ceramic speaker driver MAX 9788™ by Maxim Integrated Products™, which is hereby incorporated by reference.

FIG. 5 illustrates a schematic block diagram of an exemplary drive element control circuit according to a second embodiment of the present invention. The drive element control circuit of FIG. 5 functions similarly to the drive element control circuit of FIG. 4 with the addition of a second drive element driver circuit to generate a driving signal for a second drive element. In particular, a first drive element driver circuit 160 and a second drive element driver circuit 162 are coupled in parallel to the output of the summing circuit 150. The first drive element driver circuit 160 and the second drive element driver circuit 162 receive the same combined signal from the summing circuit 150. The combined signal is a summation of the haptic signal H1 output from the haptic signal processor 140 and the audio signal A1 output from the audio signal processor 130. The first drive element driver circuit 160 generates a driving signal for the drive element 170 and the second drive element driver circuit 162 generates a driving signal for the drive element 172. The driving signal generated by the first drive element driver circuit 160 is substantially the same as the driving signal generated by the second drive element driver circuit 162 since both drive element driver circuits 160, 162 receive as input the same combined signal output from the summing circuit 150. However, each of the drive element driver circuits 160, 162 are independently controlled and as such the driving signal output from each can be different, for example having different amplitudes. The drive element control circuit of FIG. 5 is configured to control two drive elements, as shown in FIG. 5 to be drive elements 170 and 172, and equally applicable to the drive elements 20 and 22 in FIG. 3. Although the drive element control circuit of FIG. 5 is shown to include two drive element driver circuits that drive two drive elements, the configuration can be extended to include more than two drive element driver circuits, all coupled in parallel to the summing circuit 150, where each drive element driver circuit is coupled to a drive element such that the more than two drive element driver circuits drive more than two drive elements.

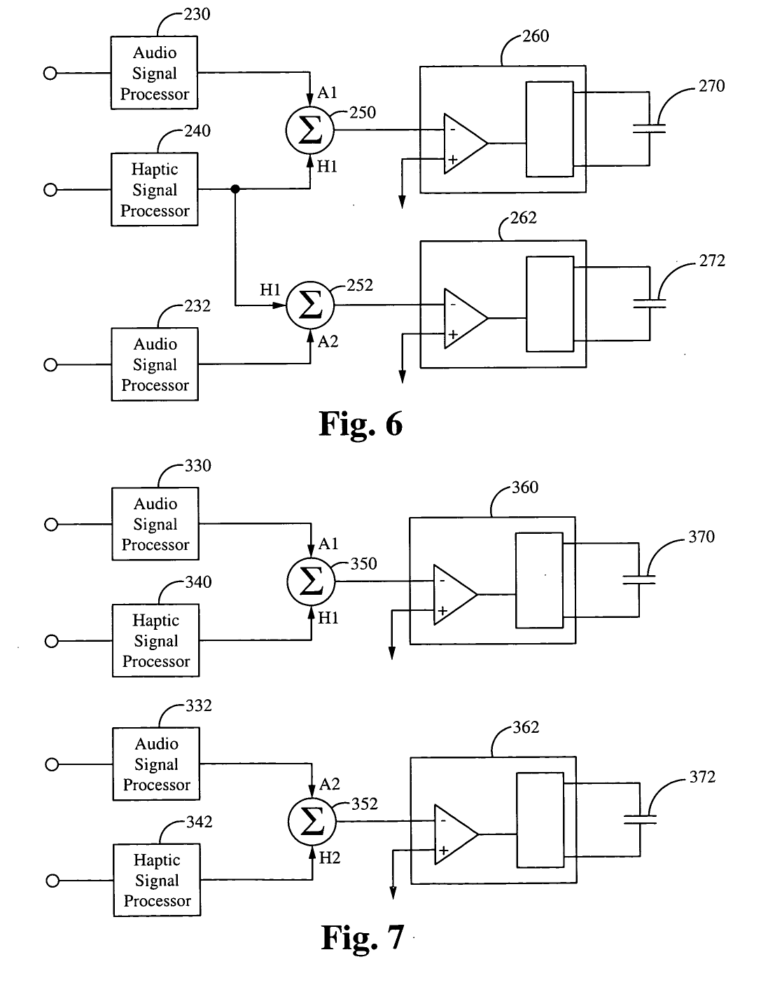

The drive element driver circuits of FIG. 5 are all driven by the same signal output from a common summing circuit. In alternative configurations, independent signals can be provided to each of the drive element driver circuits. FIG. 6 illustrates a schematic block diagram of an exemplary drive element control circuit according to a third embodiment of the present invention. The drive element control circuit of FIG. 6 functions similarly to the drive element control circuit of FIG. 5 with the exception that different audio signal components are fed to each of the drive element driver circuits. In particular, a first summing circuit 250 and a second summing circuit 252 are coupled in parallel to each receive a haptic signal H1 output from a haptic signal processor 240. The first summing circuit 250 is also coupled to a first audio signal processor 230 to receive a first audio signal A1. A first combined signal output from the first summing circuit 250 is a summation of the haptic signal H1 and the first audio signal A1. The first combined signal is input to the first drive element driver circuit 260. The first drive element driver circuit 260 generates a driving signal for the drive element 270.

The second summing circuit 252 is also coupled to a second audio signal processor 232 to receive a second audio signal A2. A second combined signal output from the second summing circuit 252 is a summation of the haptic signal H1 and the second audio signal A2. The second drive element driver circuit 262 generates a driving signal for the drive element 272.

The driving signal generated by the first drive element driver circuit 260 is independent of the driving signal generated by the second drive element driver circuit 262 since each drive element driver circuits 260, 262 receive a combined signal with a different audio signal component. Further, each of the drive element driver circuits 260, 262 are independently controlled. As each of the drive elements 270 and 272 are driven by an independent driving signal, the control panel is considered to be multi-channeled, each channel driven by one of the drive elements. In the case where the audio is provided in stereo, the first audio signal and therefore the driving signal generated by the drive element driver circuit 260 provides the left stereo component, and the second audio signal and therefore the driving signal generated by the drive element driver circuit 262 provides the right stereo component.

The drive element control circuit of FIG. 6 is configured to control two drive elements, as shown in FIG. 6 to be drive elements 270 and 272, and equally applicable to the drive elements 20 and 22 in FIG. 3. Although the drive element control circuit of FIG. 6 is shown to include two drive element driver circuits that drive two drive elements, the configuration can be extended to include more than two drive element driver circuits, all coupled in parallel to the output of the haptic signal processor 240, but each coupled to an independent summing circuit and audio signal processor. Each drive element driver circuit is coupled to a drive element such that the more than two drive element driver circuits drive more than two drive elements.

The drive element control circuit of FIG. 6 is configured to provided a multi-channeled audio signal to the plurality of drive elements such that each drive element receives a driving signal having an independently controlled audio signal portion and a haptic signal portion derived from a common haptic signal. FIG. 7 illustrates an alternative configuration of a drive element control circuit configured to provide a multi-channeled audio signal and a multi-channeled haptic signal. In this configuration, each drive element receives a driving signal having an independently controlled audio signal portion and an independently controlled haptic signal portion.

The drive element control circuit of FIG. 7 functions similarly to the drive element control circuit of FIG. 4 where there is a separate audio signal processor, haptic signal processor, summing circuit, and drive element driver circuit for each of a plurality of drive elements. In particular, a first summing circuit 350 is coupled to a first haptic signal processor 340 to receive a first haptic signal H1 and to a first audio signal processor 330 to receive a first audio signal A1. A first combined signal output from the first summing circuit 350 is a summation of the first haptic signal H1 and the first audio signal A1. The first combined signal is input to the first drive element driver circuit 360. The first drive element driver circuit 360 generates a driving signal for a drive element 370.

The second summing circuit 352 is coupled to a second haptic signal processor 342 to receive a second haptic signal H2 and to a second audio signal processor 332 to receive a second audio signal A2. A second combined signal output from the second summing circuit 352 is a summation of the second haptic signal H2 and the second audio signal A2. The second combined signal is input to a second drive element driver circuit 362. The second drive element driver circuit 362 generates a driving signal for a drive element 372. The circuit formed by the audio signal processor 330, the haptic signal processor 340, the summing circuit 350, and the drive element driver circuit 360, and the circuit formed by the audio signal processor 332, the haptic signal processor 342, the summing circuit 352, and the drive element driver circuit 362 each function similarly to the drive element control circuit of FIG. 4. Each drive element 370 and 372 vibrates the control panel 10 (FIG. 1) according to one channel of the multi-channel configuration, where both the audio signal portion and the haptic signal portion of each channel are independently controlled.

The drive element control circuit of FIG. 7 is configured to control two drive elements, as shown in FIG. 7 to be drive elements 370 and 372, and equally applicable to the drive elements 20 and 22 in FIG. 3. Although the drive element control circuit of FIG. 7 is shown to include two drive element driver circuits that drive two drive elements, the configuration can be extended to include more than two drive element driver circuits, all coupled to an independent summing circuit, audio signal processor, and haptic signal processor, where each drive element driver circuit is coupled to a drive element such that the more than two drive element driver circuits drive more than two drive elements.

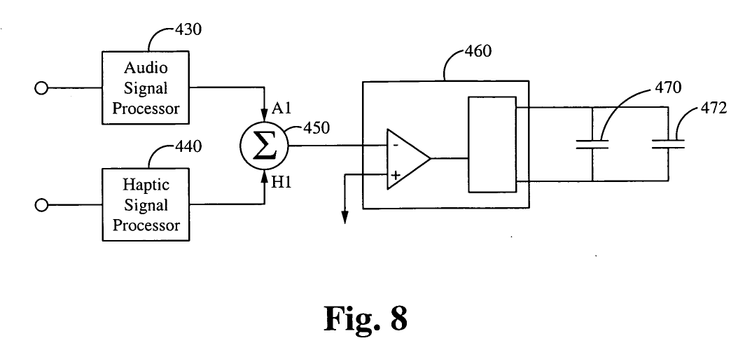

The drive element control circuits of FIGS. 4-7 are each configured with a one-to-one relationship between the drive element driver circuits and the driving elements. In other words, each drive element driver circuit is coupled to one corresponding drive element. In alternative configurations, a single drive element driver circuit is coupled to multiple driving elements, each of the multiple driving elements coupled in parallel. In this manner, a single drive element driver circuit drives multiple drive elements in parallel. FIG. 8 illustrates an alternative configuration of a drive element control circuit where a single drive element driver circuit drives multiple drive elements. The drive element control circuit of FIG. 8 functions similarly to the drive element control circuit of FIG. 4 except that a drive element driver circuit 460 drives two drive elements 470 and 472 coupled in parallel. A summing circuit 450 is coupled to a haptic signal processor 440 to receive a haptic signal H1 and to an audio signal processor 430 to receive an audio signal A1. A combined signal output from the summing circuit 450 is a summation of the haptic signal H1 and the audio signal A1. The combined signal is input to the drive element driver circuit 460. The drive element driver circuit 460 generates a driving signal that drives the drive elements 470, 472. Although the drive element control circuit of FIG. 8 is shown to include a single drive element driver circuit that drives two drive elements, the configuration can be extended such that the single drive element driver circuit drives more than two drive elements. A single drive element driver circuit used to drive multiple drive elements can be implemented in any of the drive element control circuits of FIGS. 4-7.

When using a multi-channel configuration, the driving signals applied to each of two or more of the drive elements can be tuned to generate and adjust a phase differential between the driving signals. In other words, the independently controlled drive electronics coupled to different drive elements are used to change the phasing. For symmetrically positioned drive elements driven in-phase, nulls appear at various position(s) in the control panel. A null corresponds to a position on the control panel that does not vibrate. By changing the phase differential, the null position(s) on the control panel can be moved such that certain portions of the control panel are configured to move, or vibrate, and other portions are configured to remain still. The fundamental resonant qualities of the control panel can be adjusted in this manner. The amplitude of each driving signal can also be adjusted to adjust the vibration amplitudes, and therefore the amount that the vibrating portions of the control panel move up and down. In this manner, the volume of each channel can be adjusted up and down.

Each of the drive element control circuits of FIGS. 6-7 are configured such that the inputs to the multiple audio signal processors are independent signals. Alternatively, a common input signal is input to the audio signal processors, and each audio signal processor independently processes the common input signal to generate different audio signals that are input to the corresponding summing circuits. Similarly, the drive element control circuit of FIG. 7 is configured such that the inputs to the multiple haptic signal processors are independent signals. Alternatively, a common input signal is input to the haptic signal processor, and each haptic signal processor independently processes the common input signal to generate different haptic signals that are input to the corresponding summing circuits.

Each of the drive element control circuits is described above as including separate audio processing and haptic signal processors. It is understood that the haptic signal and the audio signal can be generated separately as digital signals, and then combined together before being converted to analog. In such a configuration, the combined audio signal and haptic signal share a common path that includes the signal generator, amplifier, and drive element.

The drive element control circuits are described above in the context of applying a driving signal to a drive element that is coupled to a control panel, where the control panel includes display functionality. In general, the control electronics can be used to apply the driving signal to a drive element that is coupled to any type of medium able to be vibrated. In this manner, the driving signal is used to drive the medium to generate sound and/or haptic feedback. As previously described, the driving signal is used to vibrate a medium within a device that includes display and speaker functionality, such as a cordless telephone, a cellular telephone, a desktop telephone, a PDA, a music player, and a computing device. The driving signal can also be applied to non-display devices so as to provide audio and haptic feedback. Examples of such non-display devices include audio speakers such as ear buds, headsets, and headphones, where the haptic feedback is provided at the point of contact between the device and user, such as at the ear.

The drive element control circuits can be used to adjust the amplitude and phase of the audio signal(s), thereby adjusting the frequency response of the control panel. Adjusting the drive element control circuits in this manner enables devices utilizing the control panel apparatus to be configured to implement various conventional specifications related to audio speakers used in wireless mobile devices, including, but not limited to, cellular telephones, personal digital assistants, or other mobile audio playback devices.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. An apparatus to drive at least one transducer coupled to a touch panel, the apparatus comprising a circuit, the circuit including:
a. means for driving the transducer in response to the panel being touched, wherein the transducer is driven with a haptic signal adapted to be sensed by a typical human finger; and
b. means for driving the transducer with an audio signal wherein the circuit is configured to drive the haptic signal and the audio signal separately, alternately and concurrently.

2. The apparatus of claim 1 wherein the circuit includes an amplifier circuit.

3. The apparatus of claim 2 wherein a haptic input signal and an audio input signal are summed to form a summed signal and the summed signal is coupled as an input to the amplifier circuit.

4. An apparatus configured to provide an audio response and tactile feedback to a user, the apparatus comprising:
a. an audio signal processor configured to output an audio signal;
b. a haptic signal processor configured to output a haptic signal;
c. a summing circuit coupled to the audio signal processor and to the haptic signal processor, wherein the summing circuit is configured to sum the audio signal and the haptic signal to form a combined signal;
d. a driver circuit coupled to the summing circuit, wherein the driver circuit is configured to output a driving signal in response to the combined signal;
e. a drive element coupled to the driver circuit, wherein the drive element is configured to generate mechanical energy in response to the driving signal; and
f. a control panel coupled to the drive element, wherein the control panel is configured to provide tactile feedback in response to a haptic component of the driving signal and to provide sound in response to an audio component of the driving signal.

5. The apparatus of claim 4 wherein the control panel is configured to function as a haptic panel to output tactile feedback and audio, and is configured to function as a touchscreen panel to measure tactile input.

6. The apparatus of claim 5 wherein the control panel is a capacitive touchscreen panel or a resistive touchscreen panel.

7. The apparatus of claim 5 wherein the touchscreen panel functionality is operative while the control panel is outputting audio.

8. The apparatus of claim 4 wherein the driver circuit is configured to adjust an audio output volume generated by the control panel.

9. The apparatus of claim 4 wherein the haptic signal has a frequency response in the range of approximately 100-400 Hz.

10. The apparatus of claim 4 wherein the audio signal has a frequency response in the range of approximately 20 Hz-20 kHz.

11. The apparatus of claim 4 further comprising a chassis, and the control panel is coupled to the chassis.

12. The apparatus of claim 11 further comprising one or more compliant suspension elements positioned between the control panel and the chassis.

13. The apparatus of claim 4 wherein the audio signal processor is configured to adjust an amplitude, a phase, or the amplitude and phase of the audio signal, thereby adjusting an acoustic output of the apparatus.

14. The apparatus of claim 4 wherein the drive element comprises a piezoelectric drive element.

15. The apparatus of claim 4 wherein the drive element comprises a moving coil and magnet.

16. The apparatus of claim 4 further comprising:
a. one or more additional driver circuits, wherein the one or more additional driver circuits are coupled in parallel to the driving circuit; and
b. one or more additional drive elements, wherein each additional drive element is coupled to one of the additional driver circuits.

17. The apparatus of claim 4 further comprising one or more additional drive elements coupled in parallel to the drive element and to the driver circuit.

18. An apparatus configured to provide an audio response and tactile feedback to a user, the apparatus comprising:
a. a plurality of audio signal processors each configured to output an audio signal;
b. a haptic signal processor configured to output a haptic signal;
c. a plurality of summing circuits, each summing circuit is also coupled to one of the plurality of audio signal processors and to the haptic signal processor, wherein each summing circuit is configured to sum the audio signal and the haptic signal to form a combined signal;
d. a plurality of driver circuits, wherein each of the plurality of driver circuits is coupled to one of the plurality of summing circuits, further wherein each of the plurality of driver circuits is configured to output a driving signal in response to the combined signal;
e. a plurality of drive elements, wherein each of the plurality of drive elements is coupled to one of the driver circuits such that each drive element is driven by an independent audio signal and a common haptic signal, further wherein each of the plurality of drive elements is configured to generate mechanical energy in response to the driving signal; and
f. a control panel coupled to the plurality of drive elements, wherein the control panel is configured to provide tactile feedback in response to a haptic component of the driving signal and to provide sound in response to an audio component of each driving signal input to each of the plurality of drive elements.

19. The apparatus of claim 18 wherein the control panel is configured to function as a haptic panel to output tactile feedback and audio, and is configured to function as a touchscreen panel to measure tactile input.

20. The apparatus of claim 19 wherein the control panel is a capacitive touchscreen panel or a resistive touchscreen panel.

21. The apparatus of claim 19 wherein the touchscreen panel functionality is operative while the control panel is outputting audio.

22. The apparatus of claim 18 wherein each driver circuit is configured to adjust an audio output volume component generated by the control panel.

23. The apparatus of claim 18 wherein the haptic signal has a frequency response in the range of approximately 100-400 Hz.

24. The apparatus of claim 18 wherein each audio signal has a frequency response in the range of approximately 20 Hz-20 kHz.

25. The apparatus of claim 18 further comprising a chassis, and the control panel is coupled to the chassis.

26. The apparatus of claim 25 further comprising one or more compliant suspension elements positioned between the control panel and the chassis.

27. The apparatus of claim 18 wherein each audio signal processor is configured to adjust an amplitude, a phase, or the amplitude and phase of the audio signal, thereby adjusting an acoustic output of the apparatus.

28. The apparatus of claim 18 wherein each drive element comprises a piezoelectric drive element.

29. The apparatus of claim 18 wherein each drive element comprises a moving coil and magnet.

30. The apparatus of claim 18 wherein each of the plurality of audio signal processors, the haptic signal processor, and the plurality of driver circuits are configured to generate the plurality of driving signals out of phase relative to each other so as to vibrate one or more specific portions of the control panel according to a phase differential of the plurality of driving signals.

31. An apparatus configured to provide an audio response and tactile feedback to a user, the apparatus comprising:
a. a plurality of audio signal processors each configured to output an audio signal;
b. a plurality of haptic signal processors each configured to output a haptic signal;
c. a plurality of summing circuits, wherein each of the plurality of summing circuits is also coupled to one of the plurality of audio signal processors and to one of the plurality of haptic signal processors, wherein each summing circuit is configured to sum the audio signal and the haptic signal to form a combined signal;
d. a plurality of driver circuits, wherein each of the plurality of driver circuits is coupled to one of the plurality of summing circuits, further wherein each of the plurality of driver circuits is configured to output a driving signal in response to the combined signal;
e. a plurality of drive elements, wherein each of the plurality of drive elements is coupled to one of the driver circuits such that each drive element is driven by an independent audio signal and an independent haptic signal, further wherein each of the plurality of drive elements is configured to generate mechanical energy in response to the driving signal; and
f. a control panel coupled to the plurality of drive elements, wherein the control panel is configured to provide tactile feedback in response to a haptic component of the driving signal and to provide sound in response to an audio component of each driving signal input to each of the plurality of drive elements.

32. The apparatus of claim 31 wherein the control panel is configured to function as a haptic panel to output tactile feedback and audio, and is configured to function as a touchscreen panel to measure tactile input.

33. The apparatus of claim 32 wherein the control panel is a capacitive touchscreen panel or a resistive touchscreen panel.

34. The apparatus of claim 32 wherein the touchscreen panel functionality is operative while the control panel is outputting audio.

35. The apparatus of claim 31 wherein each driver circuit is configured to adjust an audio output volume component generated by the control panel.

36. The apparatus of claim 31 wherein each haptic signal has a frequency response in the range of approximately 100-400 Hz.

37. The apparatus of claim 31 wherein each audio signal has a frequency response in the range of approximately 20 Hz-20 kHz.

38. The apparatus of claim 31 further comprising a chassis, and the control panel is coupled to the chassis.

39. The apparatus of claim 38 further comprising one or more compliant suspension elements positioned between the control panel and the chassis.

40. The apparatus of claim 31 wherein each audio signal processor is configured to adjust an amplitude, a phase, or the amplitude and phase of the audio signal, thereby adjusting an acoustic output of the apparatus.

41. The apparatus of claim 31 wherein each drive element comprises a piezoelectric drive element.

42. The apparatus of claim 31 wherein each drive element comprises a moving coil and magnet.

43. The apparatus of claim 31 wherein each of the plurality of audio signal processors, the plurality of haptic signal processors, and the plurality of driver circuits are configured to generate the plurality of driving signals out of phase relative to each other so as to vibrate one or more specific portions of the control panel according to a phase differential of the plurality of driving signals.
